(19) United States
(12) Patent Application Publication
(10) Pub. No.: US 2004/0230822 A1
(43) Pub. Date: Nov. 18, 2004

(54) Security specification creation support device and method of security specification creation support

(75) Inventors: Tatsuya Fujiyama, Yokohama (JP); Yasuhiko Nagai, Tokyo (JP); Shigeyuki Nemoto, Kawasaki (JP)

Correspondence Address: McDermott, Will & Emery, 600, 13th Street, N.W., Washington, DC, 20005-3096, US

(73) Assignee: Hitachi, Ltd.

(21) Appl. No.: 10/674,052

(22) Filed: Sep. 30, 2003

(30) Foreign Application Priority Data
May 13, 2003 (JP) 2003-134706

(51) Int. Cl. H04L 9/00

(52) U.S. Cl. 713/200

(57) ABSTRACT

A security specification creation support device has a security specification example database in which existing security specifications are registered as examples. A definition information acceptance unit accepts the definition information of respective components constituting the information network system from the user. A security specification selection unit looks up reusable examples from the security specification example database using definition information of the component in question accepted by the definition information acceptance unit in respect of the respective components. A security specification draft creation unit creates a composite security specification draft in respect of an information network system by entering the details of respective examples found by the security specification selection unit in a prescribed form of security specification and accepts revisions of the draft in question from the user.

### INCORPORATION BY REFERENCE

This application claims priority based on a Japanese patent application, No. 2003-134706 filed on May, 13, 2003, the entire contents of which are incorporated herein by reference.

### BACKGROUND OF THE INVENTION

The present invention relates to security specifications and in particular to techniques for supporting the creation of security specifications in accordance with the International Security Evaluation Standard ISO15408.

The International Security Evaluation Standard ISO/IEC15408 (CC: common criteria) is a basis for the design and evaluation of the security function of IT (Information Technology) products. In order to carry out development of products based on this ISO15408 and to obtain evaluation/certification thereof, it is necessary to create a security requirements specification (PP: protection profile) or security design specification (ST: Security Target) specific to ISO15408. Hereinbelow, the security requirements specification and security design specification will be referred to as security specifications. In the creation of such security specifications, there is the problem that not only specialized knowledge of security in general and ISO15408 is required but also a detailed knowledge relating to the threats that are specific to the target product, examples of counter-measures, know-how relating to security, as to what type of counter-measures are effective against what type of threats, and specialized techniques relating to analysis tasks, such as risk analysis. Also, in putting into practice the analysis task such as risk assessment, there is the problem that for example an exhaustive analysis of threats and counter-measures etc and selection of security requirements appropriate to the counter-measures is necessary and an enormous amount of time is consequently required.

Security design support tools based on ISO15408 to deal with such problems are described in the CC ToolBox™ (trademark owner: National Security Agency) produced by the NIAP (The National Information Assurance Partnership), which is the US security certification body, in Non-patent Reference 1 and in Patent Reference 1.

In the security design support tools described in CC ToolBox™ and “Security Design Evaluation Support Tools (V3.0) User Manual”, Information-technology Promotion Agency Information-technology Security Center, May 2002, p. 2-69, a database is prepared in which there are recorded beforehand examples of various types of definition information such as threats or security objectives described in security specifications and definition information directly selected by the user from this database or definition information extracted from the database by user response to questions presented to the user is automatically entered at prescribed locations in the security specification. In this way, the burden of the user himself/herself arriving at definition information is reduced and automatic creation of security specifications in accordance with a prescribed form can be achieved.

Also, the security design support tools described in Laid-open Japanese Patent Publication No. 2001-222420 involve the conversion to database form of certified security specifications managed by the registration body after evaluation/certification or existing security specifications that have been previously created and make it possible not only to re-use examples of definition information of various types such as threats individually but also make it possible to re-use a set of definition information items of a certified security specification. In this way, the workload of for example risk analysis in specification creation can be reduced.

The conventional security design support tools described above assume supporting creation of a security specification in respect of individual IT products. In the case of an information network system containing as constituent elements a plurality of IT products, sometimes existing IT products and newly developed IT products are both present. The conventional security design support tools described above do not envision supporting the creation of security specifications in respect of such information network systems.

### SUMMARY OF THE INVENTION

The present invention provides a device or a method for supporting the creation of security specifications in respect of information network systems constituted by a plurality of IT products.

According to the present invention, definition information of the components constituting an information network system is accepted from the user. Next, in respect of the respective components, a search is made to ascertain whether or not a reusable security specification is present in a database that stores existing security specifications, and if such a reusable security specification is present, this is identified. After this, the details of the respective security specifications that have thus been identified are reflected into a form of security specification that has been previously prepared, thereby automatically generating a composite security specification draft in respect of the information network system, which is then presented to the user. Revisions of the composite security specification draft are then accepted from the user. In this way, creation of a security specification draft for an information network system by a user who does not have specialist knowledge/techniques or know-how is supported.

For example, a security specification creation support device according to the present invention has a security specification example database in which existing security specifications are registered as examples; a definition information acceptance unit that accepts the definition information of respective components constituting the information network system from the user; a security specification selection unit that looks up reusable examples from the security specification example database using definition information of the component in question accepted by the definition information acceptance unit in respect of the respective components; and a security specification draft creation unit that creates a composite security specification draft in respect of an information network system by entering the details of respective examples found by the security specification selection unit in a prescribed form of security specification and accepts revisions of the draft in question from the user.

The security specification selection unit, if at least one reusable example is detected from the security specification example database in respect of the respective components, causes a user to select an example for re-use from the detected examples and uses this selected example as a security specification draft for the component in question and accepts from the user revisions of this draft, but, if no reusable example is detected from the security specification example database, creates a security specification draft of the respective components by accepting from the user a security specification draft of the components. Also, the security specification draft creation unit may create the composite security specification draft by entering the details of the security specification draft of the respective components in the form of security specification.

Also, the definition information acceptance unit may accept from the user definition information of respective domains obtained by dividing the information network system into operational environment units, definition information of respective subsystems obtained by dividing these domains into device units in respect of the respective domains, and definition information of the respective components obtained by dividing these subsystems into minimum units for security analysis in respect of the respective subsystems.

Also, the security specification example database may be arranged separated from the security specification selection unit, through a network.

With the present invention, creation of a security specification in respect of an information network system constituted by a plurality of IT products can be supported.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 exemplifies an outline of the flow (principles) of processing up to creation of a composite security specification draft in respect of a system 16 to be designed, by a security specification creation support device 11 according to an embodiment of the present invention.

FIG. 2 exemplifies a system to be designed.

FIG. 3(A) exemplifies a layout 31 of a security specification (PP/ST) in accordance with the International Security Evaluation Standard ISO15408 and an example statement 33 of various types of definition information.

FIG. 3(B) shows an example 35 of a composite security specification.

FIG. 4 exemplifies a diagram of a security specification creation support device 11 according to this embodiment.

FIG. 5 exemplifies arrangements for data management of the security specification example DB 543.

FIG. 6 shows an example of registration of a system configuration example DB 544.

FIG. 7 shows an example of registration of an operation environment example DB 545.

FIG. 8 exemplifies an operational flow of a security specification creation support device 11 according to this embodiment.

FIG. 9 exemplifies the detailed flow of processing in S711 of FIG. 8 (acceptance/registration of definition information of a system to be designed).

FIG. 10(A) to FIG. 10(D) show examples of menu bars of a working screen displayed on a display device 56 by a system configuration definition PG 5421.

FIG. 11 exemplifies a TOE definition screen 92 displayed on a display device 56 by the system configuration definition PG 5421.

FIG. 12 exemplifies a domain definition screen 93 displayed on a display device 56 by the system configuration definition PG 5421.

FIG. 13 exemplifies a subsystem definition screen 94 displayed on a display device 56 by the system configuration definition PG 5421.

FIG. 14 exemplifies a component definition screen 95 shown on a display device 56 by the system configuration definition PG 5421.

FIG. 15 exemplifies a reusable example screen 96 shown on a display device 56 by a security specification selection PG 5422.

FIG. 16 exemplifies a security specification creation/editing screen 97 displayed on a display device 56 by a security specification draft creation PG 5423.

FIG. 17 exemplifies a security specification creation/editing screen 97 displayed on a display device 56 by the security specification draft creation PG 5423.

FIG. 18 shows another example of a security specification creation support device 11.

### DETAILED DESCRIPTION OF THE EMBODIMENTS

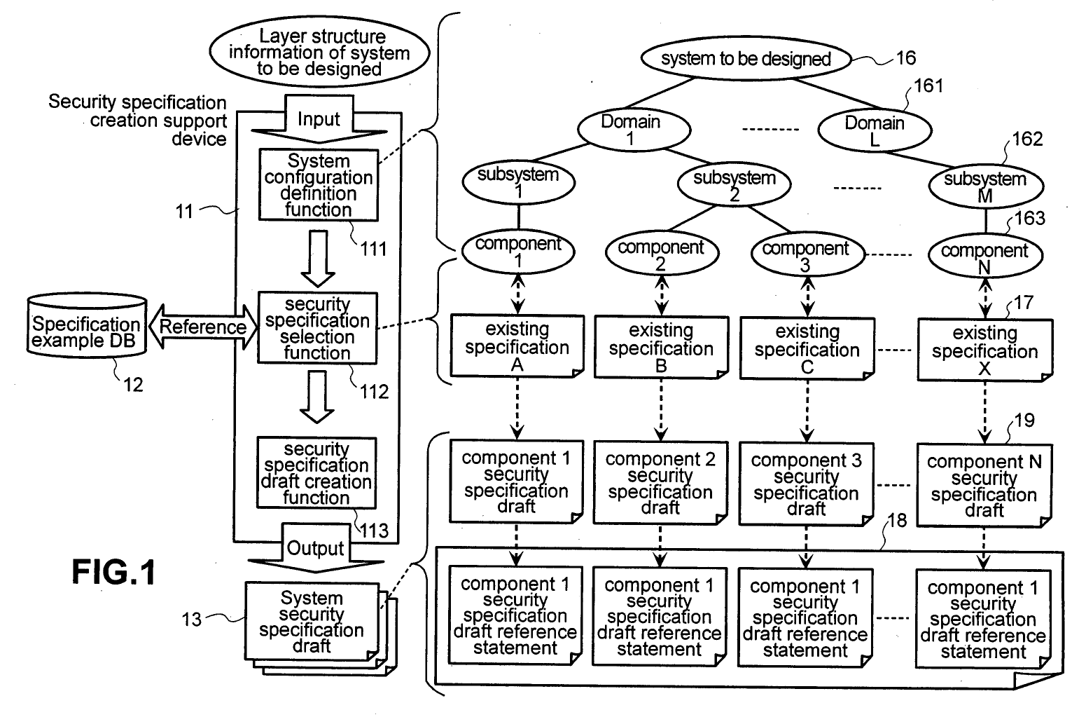

FIG. 1 shows the flow (principles) of processing, in outline, performed by a security specification creation support device 11 according to an embodiment of the present invention, up to the creation of a composite security specification draft in respect of an information network system (termed the “system to be designed”) 16, which is the subject of the creation of a composite security specification draft.

The security specification creation support device according to the present embodiment selects reusable existing security specifications in accordance with information at the system planning/design stage, such as the system configuration of the system 16 to be designed and uses these to support the creation of a composite security specification in respect of the system that is to be designed.

As shown in the drawing, the security specification creation support device 11 has a system configuration definition function 111 that defines the system 16 to be designed, a security specification selection function 112 that selects a reusable security specification that is capable of re-use in the composite security specification draft, from a specification example DB (database) 12, in which examples of security specifications are registered, and a security specification draft creation function 113 that automatically creates a draft of a composite security specification in respect of the system to be designed.

The system configuration definition function 111 accepts definition information indicating the layer structure of the system 16 to be designed from the user by means of a GUI (Graphical User Interface). Specifically, in accordance with instructions from the user, the system 16 to be designed is divided into three layers, namely, a layer 161 of domains (for example, constituent elements classified by application environment units, such as geographical conditions or company organizational structure), a subsystem layer 162 (for example constituent elements classified by device units such as IT products or network) and a component layer 163 (constituent elements classified by minimum unit in security analysis, namely, software component or hardware component). Definition information of the constituent elements is accepted from the user for each layer 161 to 163. In the case of the domain 161, the use policies in respect of each domain 1 to L and the inter-domain correspondence information relating to interfacing with other domains is accepted as definition information of the domains 1 to L. In case of the subsystem layer 162, the domains to which subsystems 1 to M belong and the inter-subsystem correspondence information are accepted as the definition information of the sub-systems 1 to M. In the case of the component layer 163, the sub-systems to which components 1 to N belong, the specific information of the components and the inter-component correspondence information are accepted as definition information of the components 1 to N.

In the specification example DB 12, existing security specifications (including for example certified security specifications, security specifications created in the past and security specifications describing the requirements of industry standards and/or clients) are registered as examples. The security specification selection function 112 searches the specification examples DB 12 for examples matching the definition information for the respective components. An existing security specification 17 that is capable of re-use in the composite security specification draft is then selected from the examples that have been found, in accordance with instructions from the user regarding the respective components.

The security specification draft creation function 113 then, for the respective components, uses the existing security specification 17 selected in respect of the component in question as a security specification draft 19 for the component in question. At this point, for components in respect of which an existing security specification 17 was not selected, a security specification newly created by the user is employed as the security specification draft 19 for the component in question. Also, the content of the respective security specification draft 19 of each component is reflected in the form of security specification that is prepared beforehand. In this way, a composite security specification draft 18 and a system security specification draft 13 having security specification draft 19 of each component are automatically generated. Also, the system security specification draft 13 accepts editing after being presented to the user through for example the GUI.

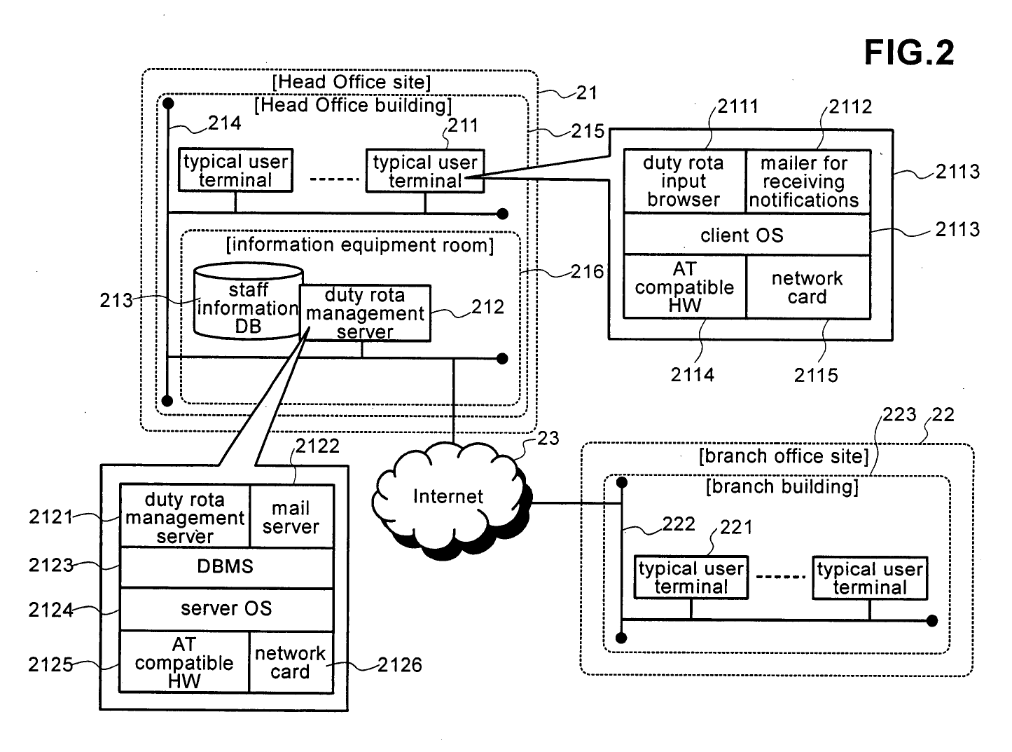

FIG. 2 shows an example of a system to be designed.

The example system to be designed shown in FIG. 2 is an information network system (duty rota management system) for performing staff duty rota management. The IT products that constitute this duty rota management system can be classified into products that are present at the Head Office site zone 21 and products that are present at the branch site zone 22.

The IT products belonging to the Head Office site zone 21 include typical user terminals 211 present within the Head Office building 215, a duty rota management server 212 and staff information DB 213 present in the information equipment room 216 of the Head Office building 215 and an intra-site network 214 that connects the IT products within the Head Office site zone 21. The IT products belonging to the branch site zone 22 include typical user terminals 221 present in the branch building 223 and an intra-site network 222 that connects the IT products within the branch site zone 22. The intra-site network 214 and the intra-site network 222 are mutually connected through the Internet 23, which is an inter-site network.

Also, the components constituting typical user terminals 211, 221 include AT compatible hardware 2114, a network card 2115, a terminal OS 2113 that runs on the AT compatible hardware 2114, a duty rota input browser 2111 that runs on the terminal OS 2113 and a mailer 2112 for reception of notifications that runs on the terminal OS 2113. The components constituting the duty rota management server 212 include AT compatible hardware 2125, a network card 2126, a server OS 2124 that runs on the AT compatible hardware 2125, a DBMS (database management system) 2123 that runs on the server OS 2124, a duty rota management server 2121 that runs on the DBMS 2123 and a mail server 2122 that runs on the DBMS 2123.

In a duty rota management system having a layout as described above, a typical user accesses the duty rota management server 212 using the duty rota input browser 2111 of a typical user terminal 211, 221 and can thereby register/refer to duty rota information. The user can also receive notifications such as requests for revision of registered information through the mailer 2112 for notification reception at typical user terminals 211, 221.

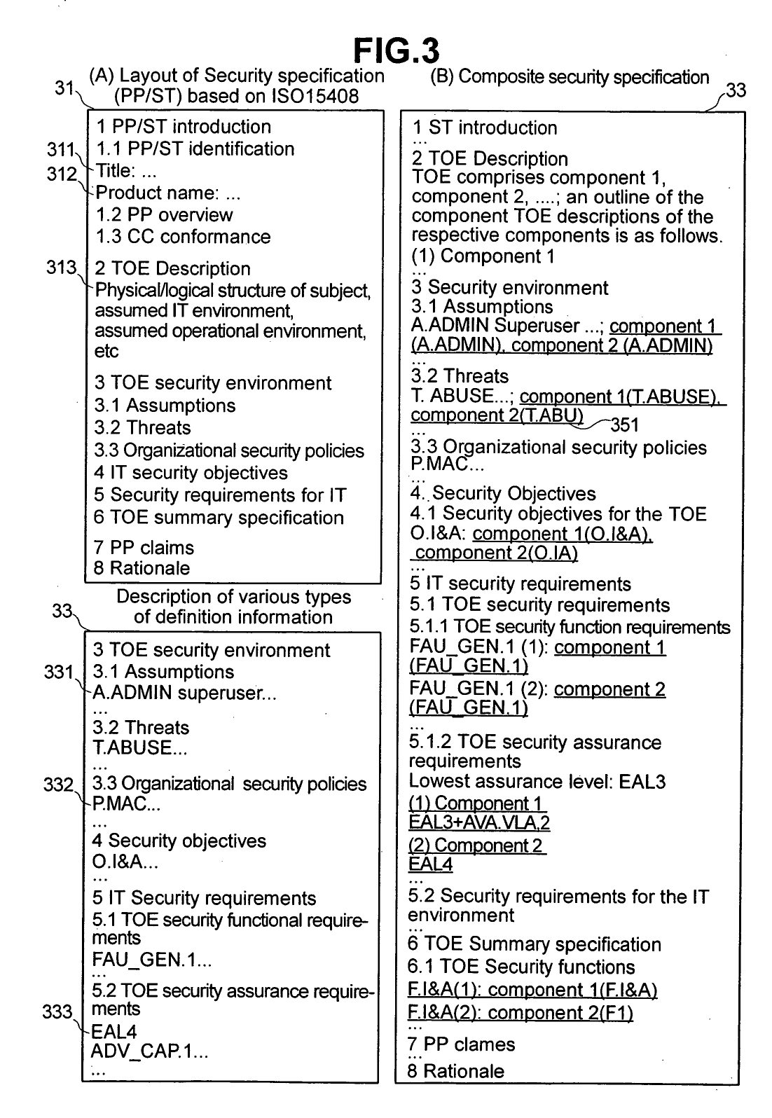

FIG. 3 is a view given in explanation of a security specification that supports creation by a security specification creation support device 11.

FIG. 3(A) shows an example layout 31 of a security specification (PP/ST) in accordance with the International Security Evaluation Standard ISO15408 and an example statement 33 of each type of definition information. As shown in the drawing, the security specification in accordance with ISO15408 is provided with a plurality of prescribed items including a specification title 311, product name 312, TOE (Target of Evaluation) description 313, assumptions 331, organizational security policies 332, evaluation assurance level 333 and so on. A security specification in accordance with ISO15408 specifies the layout of the table of contents and the descriptive details to be given in each item of the table of contents. Consequently, if it is possible to specify in which item of the table of contents the target information is to be found, the target information can be referred to as appropriate or extracted from the security specification.

FIG. 3(B) shows an example 35 of a composite security specification. As shown in the Figure, the composite security specification is based on the International Security Evaluation Standard ISO15408. As described above, a system security specification draft 13 that supports creation by the security specification creation support device 11 of the present embodiment is constituted having a security specification draft 19 of each component that constitutes the system 16 to be designed and a composite security specification draft 18 of the system to be designed. A composite security specification draft 18 is automatically generated such that the security specification draft 19 of the components that are described corresponding to the security environment description of the system to be designed and/or the security objectives for the system to be designed, the security requirements and the descriptive details of the security specification draft 19 of the components that are to realize the security function are referred to (reflected) therein. In this way, the entire system is described without omission. In an example 35 of a composite security specification, a composite security specification is created such that it is possible to identify the portions (portions with underlining 351) where descriptive details of the security specification of each component are referred to.

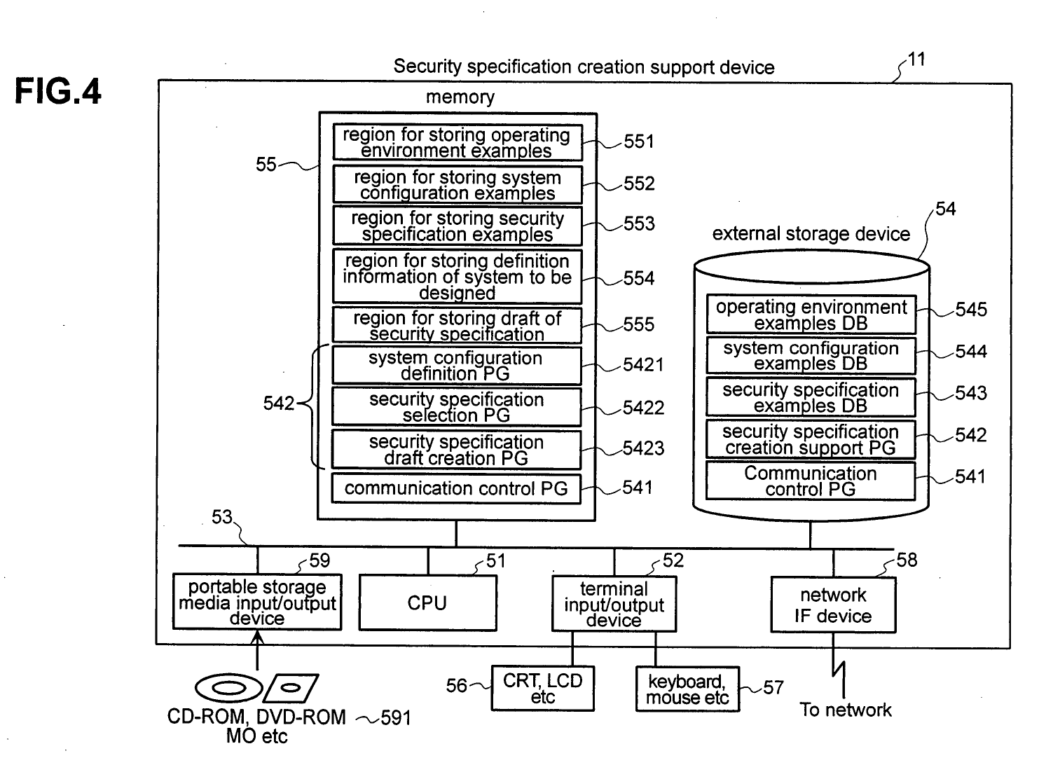

FIG. 4 is a layout diagram of security specification creation support device 11 according to this embodiment. As shown in Figure, the security specification creation support device 11 of this embodiment is implemented by a CPU 51 executing a communication control PG (program) 541 and a security specification compilation and support PG 542 loaded in memory 55 in an ordinary computer system having a CPU 51, memory 52, an external storage device 54 such as an HDD, a terminal input/output device 52 that presents information to a user and that accepts information from a user through a display device 56 such as an LCD or CRT and input devices 57 such as a keyboard and mouse, a network IF (interface) device 58 for performing communication through a network, a portable storage input/output device 59 that controls reading/writing of portable media such as a CD-ROM, DVD-ROM, MO or floppy disk, and a bus 53 that mutually connects these devices.

The communication control PG 541 is a program for performing communication by the CPU 51 with another network terminal connected with the network and through the network IF device 58. Also, the security specification creation support PG 542 is a program for implementing the system configuration definition function 111, the security specification selection function 112 and security specification draft creation function 113 shown in FIG. 1. In this embodiment, the security specification creation support PG 542 has three programs, namely, a system configuration definition PG 5421 for implementing the system configuration definition function 111, a security specification selection PG 5422 for implementing the security specification selection function 112 and a security specification draft creation PG 5423 for implementing the security specification draft creation function 113. The communication control PG 541 and security specification creation support PG 542 are stored beforehand on for example an external storage device 54 or portable storage media 591. These are then loaded into memory 55 from the external and storage device 54 or from portable storage media 591 through the portable storage media input/output device 59.

The various DB 543 to 545 are stored on the external storage device 54 or portable storage media 591. The certified security specifications, previously created security specifications and existing security specifications including security specifications stating industry standard or client requirements are registered as examples in the security specification example DB 543, and correspond to the specification example DB 12 shown in FIG. 1.

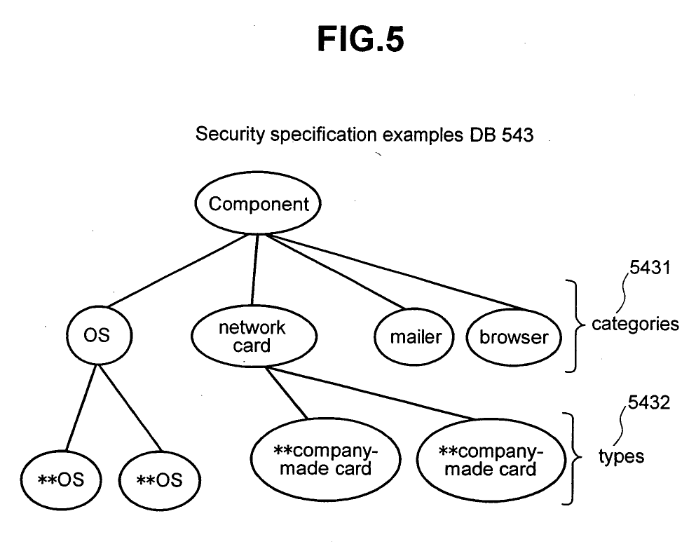

FIG. 5 is a view given in explanation of the arrangements for data management of the security specification example DB 543. As shown in this Figure, the security specification example DB 543 is organized in a database form such that it can be searched using as keys the category 5431 indicating the type of component and the type 5432, indicating the form of components of the same type.

In the system configuration example DB 544, typical system deployment patterns of each subsystem constituting an information network system are registered as system configuration examples. By a “system deployment pattern” is meant data for identifying the tree configuration of the subsystem; thus it is possible to identify each component constituting a subsystem by means of the system deployment pattern.

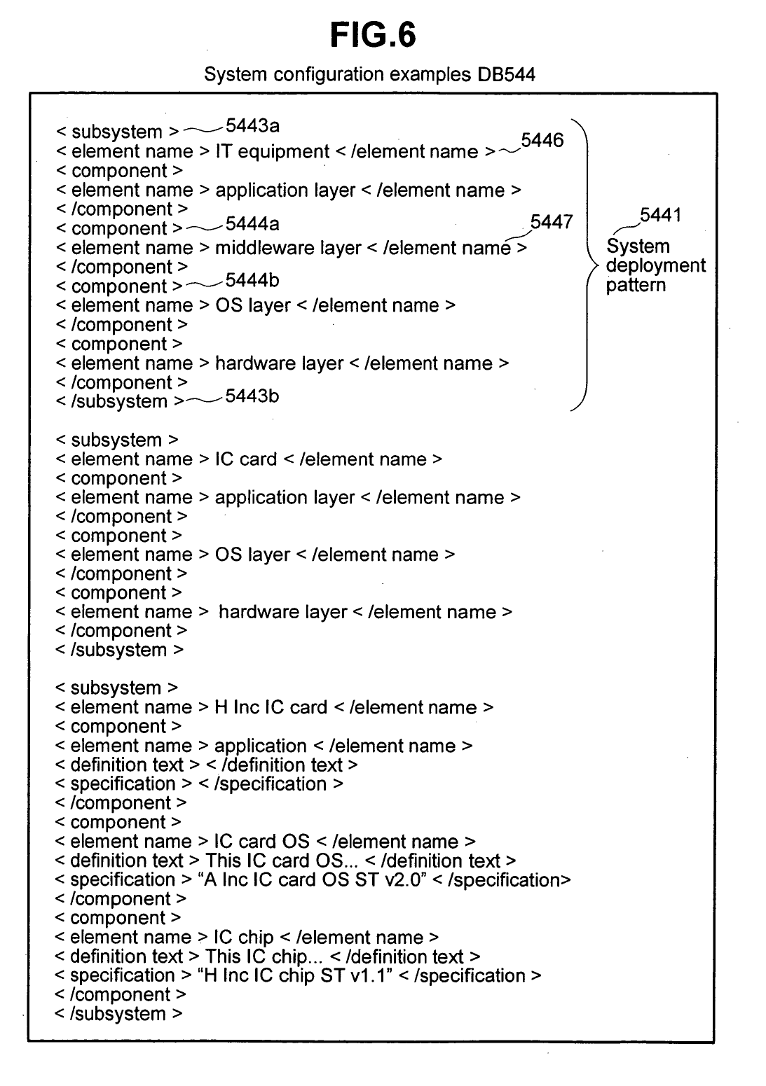

FIG. 6 is a view showing an example of registration of a system configuration example DB 544. As shown in this Figure, in this embodiment, the system deployment pattern 5441 is described in tag form. In this case, the name of a subsystem and information of the components constituting this subsystem are set out in a region enclosed by the <subsystem> tag 5443a and </subsystem> 5443b, and the type of the subsystem are set out in a region 5446 enclosed by the two tags <element name>, </element name> that are located after the <subsystem> tag 5443a. Also, the name of the component and information relating to the definition or specification of this component are set out in a region enclosed by the <component> tag 5444a and </component> 5444b and the type of component is set out in a region 5447 enclosed by the two tags <element name> and </element name> located after the <component> tag 5444a. The system configuration example DB 544 is organized in database form such that a desired subsystem system deployment pattern 5441 can be looked up using the subsystem type as the search key In the operational environment example DB 545, operational environment patterns of each subsystem of the information network systems previously created by system security specifications are registered as operational environment examples. By the term “operational environment pattern” is meant a pattern that is constituted by recording the objectives and/or assumptions that are applied to the components of each system in the system deployment pattern of subsystems.

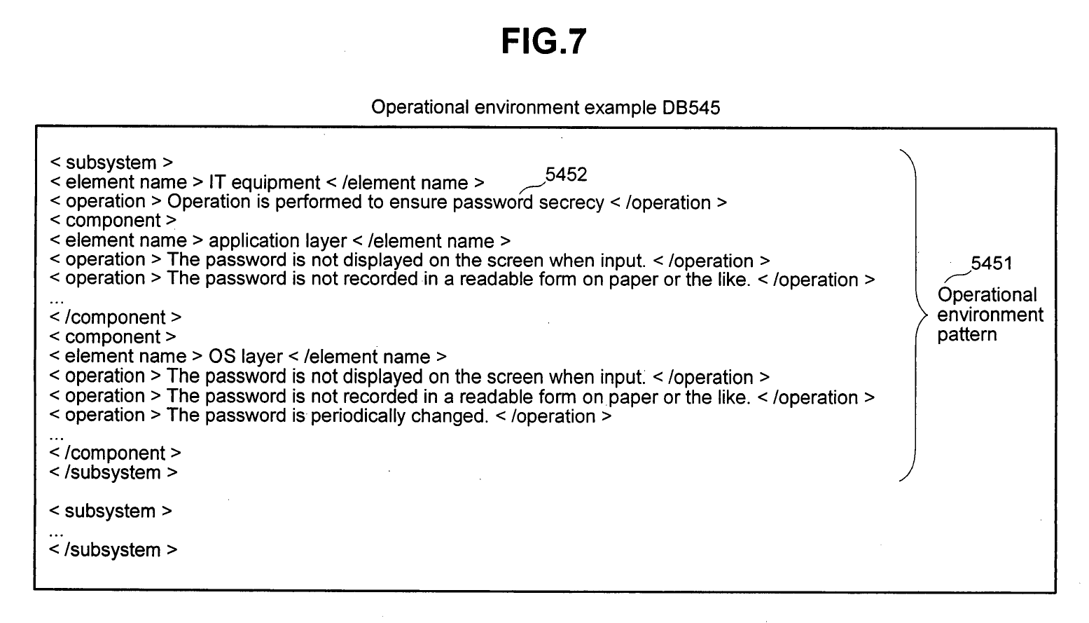

FIG. 7 is a view showing an example of registration of the operational environment example DB 545. As shown in this Figure, an operational environment pattern 5451 is constituted by providing regions 5452 (regions enclosed by the two tags <operation>, </operation>) for stating the use policies and/or assumptions applied to the corresponding constituent elements, in each statement region of the respective sub-systems and components in the system deployment pattern 5441 shown in FIG. 6. The operational environment example DB 545 is also organized in database form such that a desired subsystem operational environment pattern 5451 can be looked up using as search key the type of subsystem, just as in the case of the system configuration example DB 544.

Also, in the memory 55, by executing the security specification creation support PG 542 that is loaded in the memory 55 by the CPU 51, there are respectively formed an operational environment example storage region 551 for temporarily storing operational environment examples read from the operational environment example DB 545, a system configuration examples storage region 552 for a temporary storing system configuration examples read from the system configuration example DB 544, a security specification examples storage region 553 for temporally storing security specification examples read from the security specification example DB 543, a definition information storage region 554 of the system to be designed for temporally storing definition information of the system to be designed and a security specification draft storage region 555 for temporally storing a security specification draft of the system to be designed.

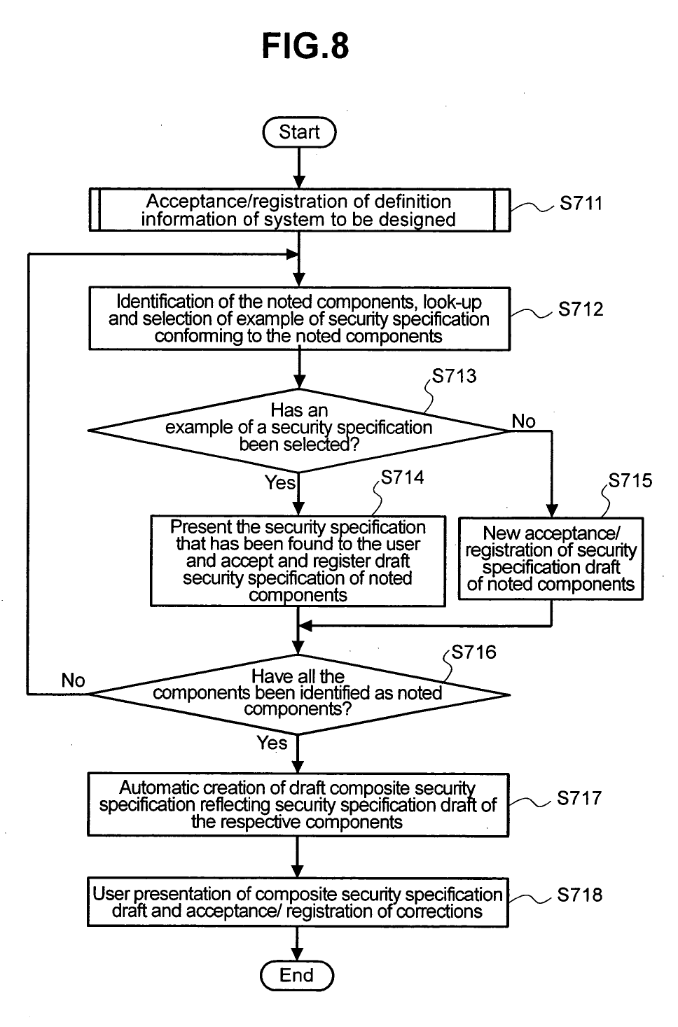

FIG. 8 is a view given in explanation of the operational flow of the security specification creation support device 11 according to this embodiment.

First of all, the system configuration definition PG 5421 accepts definition information indicating the layer structure of the system that is to be designed from the user in conversational fashion through the terminal input/output device 52. The definition information of the system to be designed is then stored in the definition information storage region 554 of the system to be designed (S711).

Next, the security specification selection PG 5422 extracts a single component from among the components identified by the definition information of the system to be designed that are stored in the definition information storage region 554 of the system to be designed and designates this as a noted component. Furthermore, examples of security specifications matching the definition information of the noted component (category 5431, type 5432) are detected. Then, from among the detected examples, an example of a security specification that can be re-used in respect of the noted component (for example, an example of a security specification conforming to the security policy of the domain to which the component belongs) is selected (S712) in accordance with the user's instructions.

Next, if the security specification selection PG 5422 has succeeded in selecting (Yes in S713) an example of a security specification that is capable of re-use in respect of the noted component, this is read from the security specification example DB 543 and stored in the security specification example storage region 553. Next, the security specification draft creation PG 5423 presents the example of the security specification that is stored in the security specification example storage region 553 to the user through the terminal input device 52 to accept revisions thereof. In this way, a security specification draft in respect of the noted component is created. Also, the security specification draft in respect of the noted component is stored (S714) in the security specification draft storage region 555 in such a way that it can be seen that this is based on an example of an existing security specification, in accordance with registration instructions from the user. After this, processing shifts to S716.

On the other hand, if the security specification selection PG 5422 failed to select an example of a security specification capable of re-use in respect of the noted component (No. in S713), the security specification draft creation PG 5423 accepts a new security specification draft in respect of the noted component from the user through the terminal input device 52. Also, the security specification draft in respect of the noted component is stored (S715) in the security specification draft storage region 555 in such a way that it can be seen that this is a newly created security specification. After this, processing shifts to S716.

Next, in S716, the security specification selection PG 5422 checks to ascertain whether or not any noted component has not yet been extracted from the components identified by the definition information of the system to be designed. If there is no such component that has not yet been extracted (No in S716), processing returns to S712.

Furthermore, if all of the components identified by the definition information of the system to be designed to have been extracted as noted components i.e. a security specification draft in respect of all of the components identified by the definition information of the system to be designed has been stored in the security specification draft storage region 555 (Yes in S716), the security specification draft creation PG 5423 automatically creates (S717) a composite security specification draft in respect of the system to be designed by causing the details of the security specification draft of the respective components to be reflected in the form of security specification that is prepared beforehand.

Specifically, in respect of a given item of the table of contents of a security specification in accordance with ISO15408, the descriptive details in this item of the contents are extracted from the security specification draft of the component, these are prepared beforehand, and added to the details description section of the table of contents item in question in the form of security specification. At this point, linking information to the reference source (security specification draft of the component) of the descriptive details that have been added is added. The above processing is performed, repeated for all the items of the table of contents of the security specification in accordance with ISO15408 and a composite security specification draft is thereby automatically created in respect of the system to be designed, reflecting the details of the security specification draft of each component.

Next, the security specification draft creation PG 5423 presents to the user an automatically generated composite security specification draft in respect of the system to be designed through the terminal input device 52 and accepts revisions thereof. The composite security specification draft relating to the system to be designed is then stored in the security specification draft storage region 555 in accordance with registration instructions from the user (S718).

The composite security specification draft and the security specification draft of the respective components stored in the security specification storage region 555 are then presented to the user through the terminal input/output device 52 as a system security specification draft for the system to be designed and stored in portable storage media 591 mounted in an external storage device 54 or portable storage media input/output device 59 or transmitted to the network through a network IF device 58.

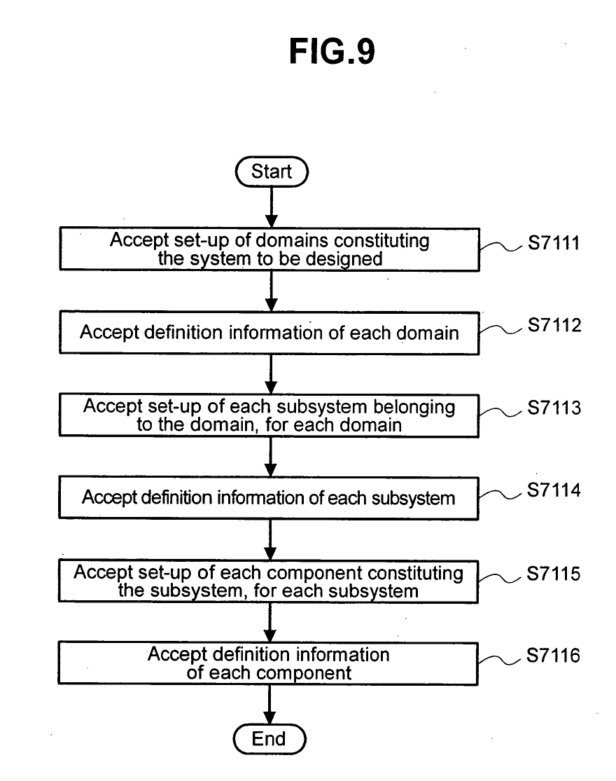

FIG. 9 is a view showing the detailed flow of processing in step S711 of FIG. 8 (acceptance/registration of definition information of the system to be designed).

First of all, the system configuration definition PG 5421 accepts (S7111) set-up of each domain constituting the system to be designed from the user through the terminal input device 52. The system to be designed is divided into a plurality of domains constituting subsystem groups to which common objectives are applied by the user in accordance with for example geographical conditions or company organizational structure. The set-up of the domains is input to the security specification creation support device 11.

Next, the system configuration definition PG 5421 accepts, as domain definition information, the inter-domain correspondence information relating to domain-specific information and interfacing with other domains, including the objectives, for the domains accepted in the above S7111, from the user through the terminal input device 52 (S7112).

Next, the system configuration definition PG 5421 accepts (S7113) set-up of the subsystems belonging to the domain in question for the respective domains from the user through the terminal input device 52. For the respective domains, the user identifies the individual subsystems such as the IT product and network infrastructure belonging to the domain in question and inputs the setting of the respective subsystems that have been identified to the security specification creation support device 11.

Next, the system configuration definition PG 5421 accepts the subsystem-specific information and inter-subsystem correspondence information relating to interfacing with other subsystems in respect of the subsystems that were accepted in the above S7113 from the user through the terminal input device 52 as subsystem definition information (S7114).

Next, the system configuration definition PG 5421 accepts set-up of the components constituting the subsystems in question in respect of the respective subsystems, from the user through the terminal input device 52 (S7115). For the respective subsystems, the user identifies the individual components such as the software components and hardware components constituting the subsystem in question and inputs the setting of the respective identified components to the security specification creation support device 11.

Next, the system configuration definition PG 5421 accepts, as component definition information, component-specific information and inter-component correspondence information relating to interfacing with other components in respect of the components accepted in the aforementioned S7115 from the user through the terminal input device 52 (S7116).

Once the definition information of the domains, subsystems and components has been accepted as described above, the system configuration definition PG 5421 stores these items of definition information in the definition information storage region 554 of the system to be designed, as definition information indicating the layer structure of the system to be designed.

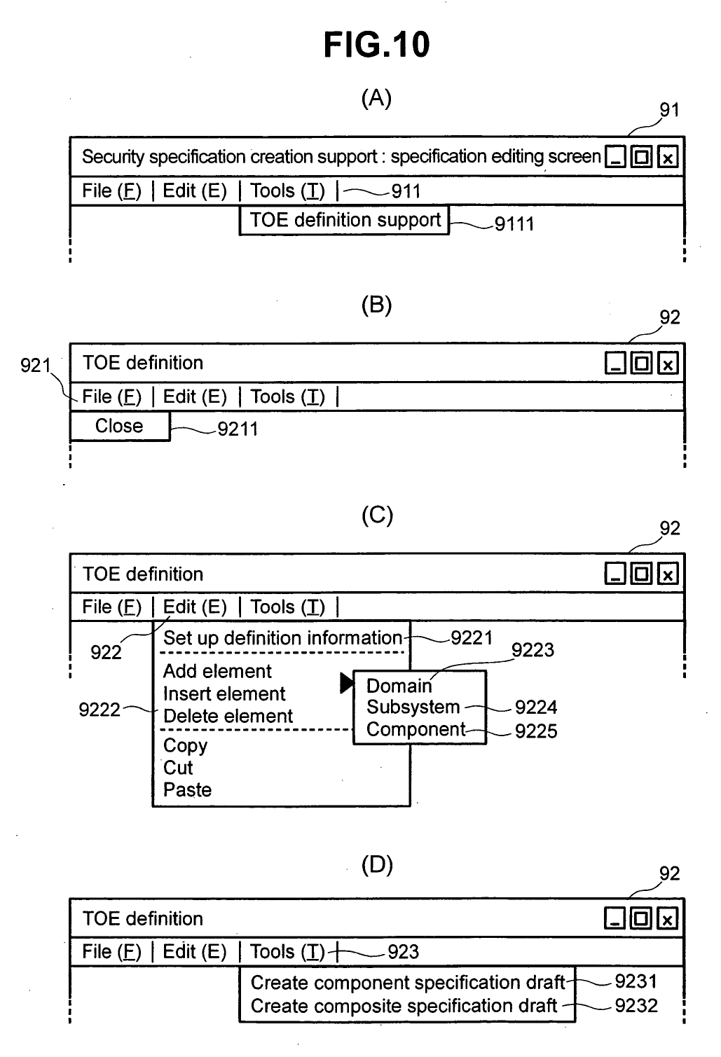

FIG. 10 is a view showing an example of a menu bar of a working screen displayed on the display device 56 by the system configuration definition PG 5421. First of all, the operating procedure and screen layout in S711 of FIG. 8 (acceptance of definition information of the system to be designed) will be described using FIG. 10.

As shown in FIG. 10(A), the system configuration definition PG 5421 displays as the initial screen a specification editing screen 91. By operating the cursor (not shown) through an input device 57, the user selects the item “TOE definition support” 9111 from the menu bar item “Tools” 911; the TOE definition screen 92 that displays the system deployment tree (layer structure of the system to be designed) specified by the definition information of the system to be designed stored in the definition information storage region 554 of the system to be designed is then displayed on the display device 56 through the terminal input/output device 52. To close this TOE definition screen 92, as shown in FIG. 10(B), the user may select the item “Close” 9211 from the menu bar item “File” 921.

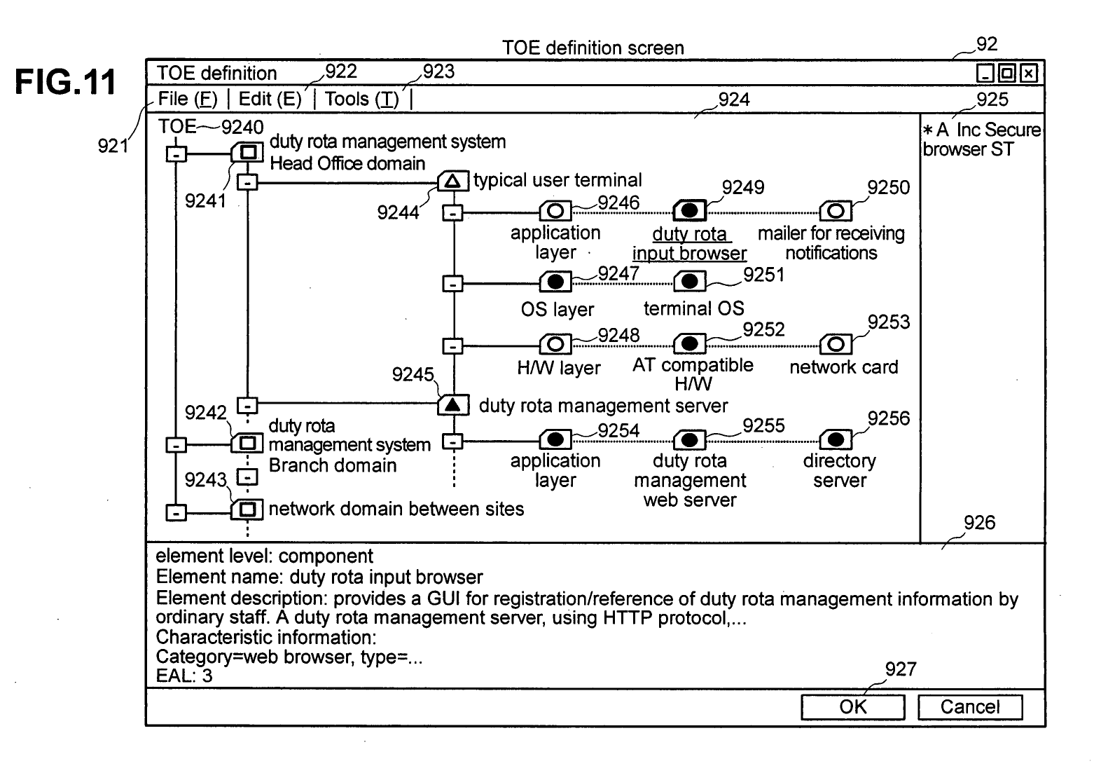

FIG. 11 shows an example of a TOE definition screen 92 displayed on the display device 56 by the system configuration definition PG 5421. In this example, the case is displayed in which the item “TOE definition support” 9111 is selected after execution of the flow shown in FIG. 8 and storage of the definition information of the duty rota management system shown in FIG. 2 in the definition information storage region 554 of the system to be designed, in a condition in which a system security specification draft of the duty rota management system has been stored in the security specification draft storage region 555.

The system configuration definition PG 5421 displays the system deployment tree identified by the definition information of the system to be designed stored in the definition information storage region 554 of the system to be designed in the display frame 924. It should be noted that, in a condition in which no definition information of the system to be designed is stored in the definition information storage region 554 of the system to be designed, in other words, in a condition in which definition information of the system to be designed is still to be accepted, nothing is displayed in the display frame 924.

In FIG. 11, the nodes 9241 to 9243 with rectangular marks constitute domains. In the case of the duty rota management system shown in FIG. 2, these can be divided into three domains, namely, the “Head Office site zone” domain 9241, “branch site zone” domain 9242 and “intersite network” domain 9243. As shown in FIG. 10(C), to add a domain, the item “Add Element” 9222 is selected from the item “Edit” 922 of the menu bar on the TOE definition screen 92 by operating the cursor (not shown) through the input device 57, and further selecting the item “Domain” 9223. In this way, the system configuration definition PG 5421 displays addition of a new node with a rectangular mark, connected to the “TOE” node 9240 (S7111 of FIG. 9).

Also, in FIG. 11, the nodes 9244, 9245 with triangular marks are subsystems. In the case of the duty rota management system shown in FIG. 2, for example the “typical user terminal” subsystem 9244 and “duty rota management server” subsystem 9245 belong to the “Head Office site zone” domain 9241. As shown in FIG. 10(C) addition of a subsystem is performed by operating the cursor (not shown) through the input device 57 so as to select the item “Add Element” 9222 in the TOE definition screen 92 from the item “Edit” 922 of the menu bar and, furthermore, to select the item “Subsystem” 9224 and designate a node of the desired domain. In this way, the system configuration definition PG 5421 displays addition of a new node with a triangular mark connected to the node of the desired domain (S7113 of FIG. 9).

Also, in FIG. 11, the nodes 9246 to 9256 with the circle marks are components. In the case of the duty rota management system shown in FIG. 2, for example the component “application layer” 9246, the component “browser for duty rota input” 9249, the component “mailer for receiving notifications” 9250, the component “OS layer” 9247, “terminal OS” 9251, the component “hardware layer” 9248, the component “AT compatible hardware” 9252 and “network card” 9253 belong to the “typical user terminal” subsystem 9244. It should be noted that, as shown in FIG. 10(C), addition of a component is performed by operating the cursor (not shown) through the input device 57 so as to select the item “Add Element” 9222 in the TOE definition screen 92 from the item “Edit” 922 of the menu bar and, furthermore, to select the item “Component” 9225 and designate the node of a desired subsystem or component. In this way, the system configuration definition PG 5421 displays addition of a new node with a circle mark connected to the node of the desired subsystem or component (S7115 of FIG. 9).

Component nodes can be displayed by the method of expanding components of the same layer in the horizontal direction, so as to enable connection not only to subsystem nodes but also to other component nodes. In this way, it is possible to identify both groups of elements (domains, subsystems) that are horizontally dispersed in a network-connected relationship and groups of elements (components) that are expanded vertically such as the layer structure of an IT product.

Also, the system configuration definition PG 5421 displays in the display frame 926 definition information of a node selected by the user by operating the cursor (not shown) from the system deployment tree displayed in the display frame 924. In the example shown in FIG. 11, the component “duty rota input browser” 9249 is selected and its definition information is displayed in the display frame 926. It should be noted that, in the definition information storage region 554 of the system to be designed, nothing is displayed in the display frame 926 in a condition in which no definition information of the selected node is stored i.e. in a condition in which the definition information of the node in question is yet to be accepted.

Also, as shown in FIG. 10(C), when the user selects the item “Set Definition Information” 9221 from the menu bar item “Edit” 922 in the TOE definition screen 92 by designating the node of the domain displayed in the display frame 924 by operating the cursor (not shown), the system configuration definition PG 5421 displays on the display device 56 through the terminal input/output device 52 the definition information of the domain in question that is stored in the definition information storage region 554 of the system to be designed and also displays the domain definition screen 93 for acceptance of revisions of the definition information of the domain in question.

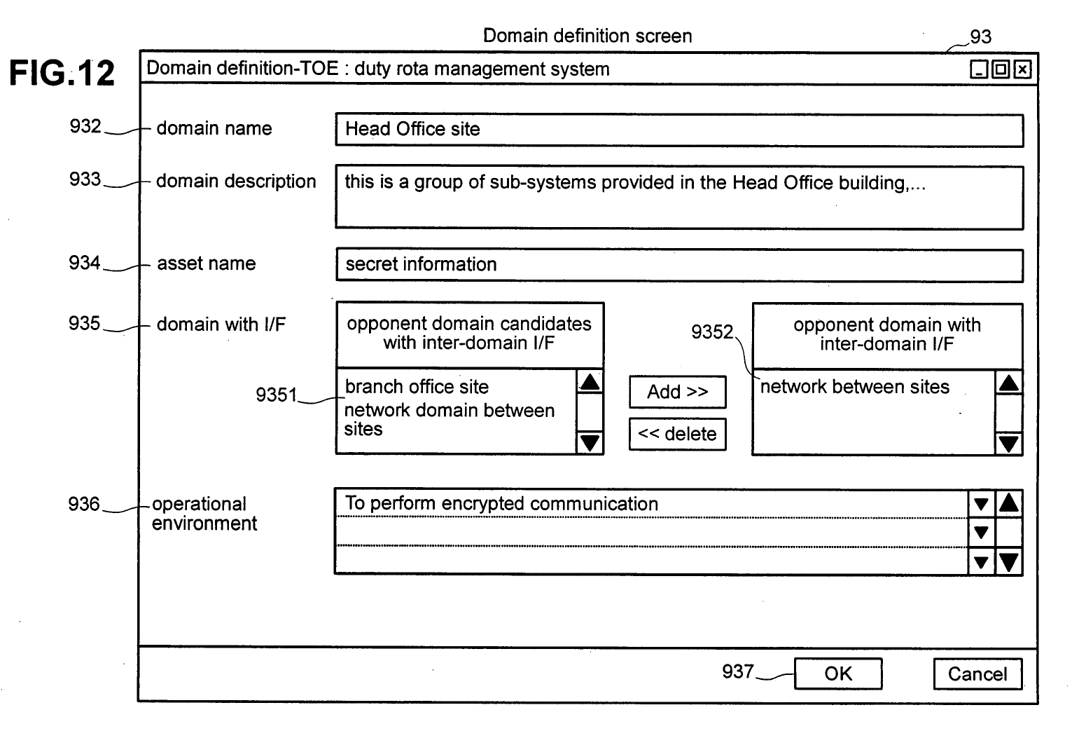

FIG. 12 shows an example of a domain definition screen 93 displayed on the display device 56 by the system configuration definition PG 5421. This example shows the display in the case where the domain “Head Office site zone” 9241 is designated in FIG. 11 and the definition information of the domain “Head Office site zone” 9241 is already stored in the definition information storage region 554 of the system to be designed.

As shown in the Figure, the domain definition screen 93 has, as the input column for the domain-specific information, the domain title, the domain description, which is a detailed description of the domain, and input columns 932 to 534 of the assets in the domain that are to be protected. Also, as the input column for the inter-domain correspondence information, there is provided a setting column 935 for setting a remote domain having an interface with the current domain. The setting column 935 has a remote candidate display column 9351 for tabular display, as remote domain candidates, of domains constituting the system that is to be designed, and a remote display column 9352 that displays a remote domain selected from this remote candidate display column 9351. There is also provided an input column 936 for inputting the operational environment such as the objectives and assumptions to be applied to the target domain.

It should be noted that, in the definition information storage region 554 of the system to be designed, nothing is displayed in the input columns 932 to 934, 936 and the remote display column 9352 in the condition where no definition information of the designated domain has been stored i.e. in a condition in which the definition information of the domain in question has yet to be accepted.

When appropriate information is input to the input columns 932 to 934, 936 by the user through the terminal input/output device 52 and a remote domain is displayed in the remote display column 9352 by selecting a remote domain and the OK button 937 is selected, the system configuration definition PG 5421 registers or updates (S7112 of FIG. 9) the domain-specific information that is displayed in the input columns 932 to 934, 936 and the remote display column 9352 and inter-domain correspondence information and operational environment information in the definition information storage region 554 of the system to be designed, as definition information of the domain in question.

Also, as shown in FIG. 10(C), when the user designates a subsystem node displayed in the display frame 924 by operating the cursor (not shown) and selects the item “Set Definition Information” 9221 from the item “Edit” 922 of the menu bar in the TOE definition screen 92, the system configuration definition PG 5421 displays on the display device 56 through the terminal input device 52 the definition information of the subsystem in question that is stored in the definition information storage region 554 of the system to be designed and displays the subsystem definition screen 94 for acceptance of revisions of the definition information of the subsystem in question.

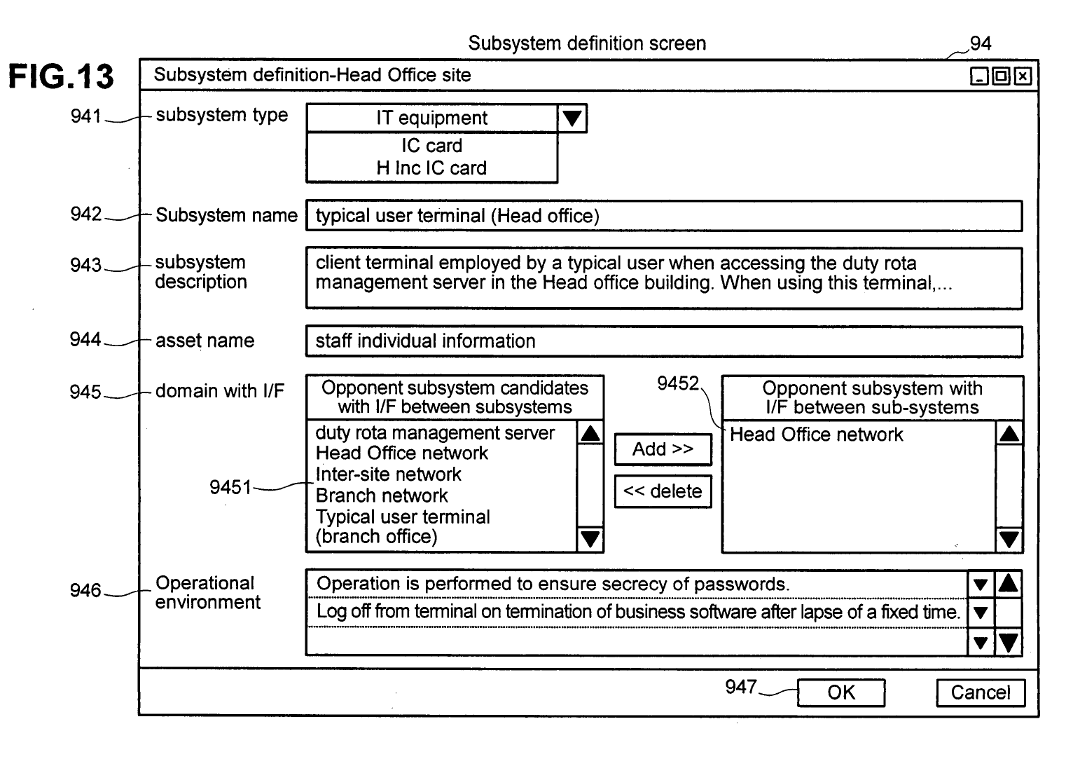

FIG. 13 shows an example of the subsystem definition screen 94 displayed on the display device 56 by the system configuration definition PG 5421. In this example, the display is shown of the case in which the subsystem “typical user terminal” 9244 is designated in FIG. 11 and the definition information of the subsystem “typical user terminal” 9244 is already stored in the definition information storage region 554 of the system to be designed.

As shown in this Figure, the subsystem definition screen 94 has as input columns for subsystem-specific information input columns 941 to 944 for the subsystem type, which indicates the type of device, the name of the subsystem, the subsystem description, which is a detailed description of the subsystem and the assets to be protected in the subsystem. Also, as an input column for the inter-subsystem correspondence information, there is provided a setting column 945 for setting the remote subsystems having interfaces with the target subsystem. The setting column 945 has a remote candidate display column 9451 that displays in tabular form as remote subsystem candidates subsystems belonging to the same domain and subsystems of other domains that are in a connected relationship through the network, and remote display column 9452 that displays remote subsystems that are selected from this remote candidate display column 9451. There is also provided an input column for inputting the operation environment such as the objectives and assumptions to be applied to the target subsystem.

It should be noted that, in the definition information storage region 554 of the system to be designed, nothing is displayed in the input columns 941 to 944, 946 and the remote display column 9452 in a condition in which no definition information of the designated subsystem has been stored i.e. a condition in which the definition information of the subsystem in question has not yet been accepted.

When the user inputs suitable information to the input columns 941 to 944, 946 through the terminal input/output device 52 and causes a remote subsystem to be displayed in the remote display column 9452 by selecting a remote subsystem and selects the OK button 947, the system configuration definition PG 5421 registers or updates the subsystem-specific information, inter-subsystem correspondence information and operation environment information displayed in the input columns 941 to 944 and 946 and the remote display column 9452 as the definition information of the subsystem in question in the definition information storage region 554 of the system to be designed (S7114 of FIG. 9).

If, at this point, a subsystem type is input in the input column 941 for the subsystem type, the system configuration definition PG 5421 may look up the system deployment pattern 5441 of the subsystem from the system configuration example DB 544, using this type as a search key. If a system deployment pattern 5441 is then detected, the components identified by the detected system deployment pattern 5442 may then be additionally displayed in the display frame 924 of the TOE definition screen 92 shown in FIG. 11 as components constituting the target subsystem, and these may be arranged to be connected to the node of the target subsystem. For example, if the subsystem type “IT device” is input in the input column 941 and the OK button 947 is selected, the system configuration definition PG 5421 looks up the system deployment pattern 5441 of the subsystem type “IT device” and sets the components (in the example shown in FIG. 6, the application layer, middleware layer, OS layer and hardware layer) identified by this pattern 5441 as the components constituting the target subsystem. The nodes of the each components connected to the node of the target subsystem are then added to the display in the display frame 924 of the TOE definition screen 92 shown in FIG. 11. In this way, addition of components constituting the target subsystem can be automated.

Also, as shown in FIG. 10(C), if, in the TOE definition screen 92, the item “Set Definition Information” 9221 is selected from the item “Edit” 922 of the menu bar after specifying the node of the component displayed in the display frame 924 by the user operating the cursor (not shown), the system configuration definition PG 5421 displays the definition information of the component in question stored in the definition information storage region 554 of the system to be designed and displays the component definition screen 95 for acceptance of revisions of the definition information of the component in question on the display device 56 through the terminal input/output device 52.

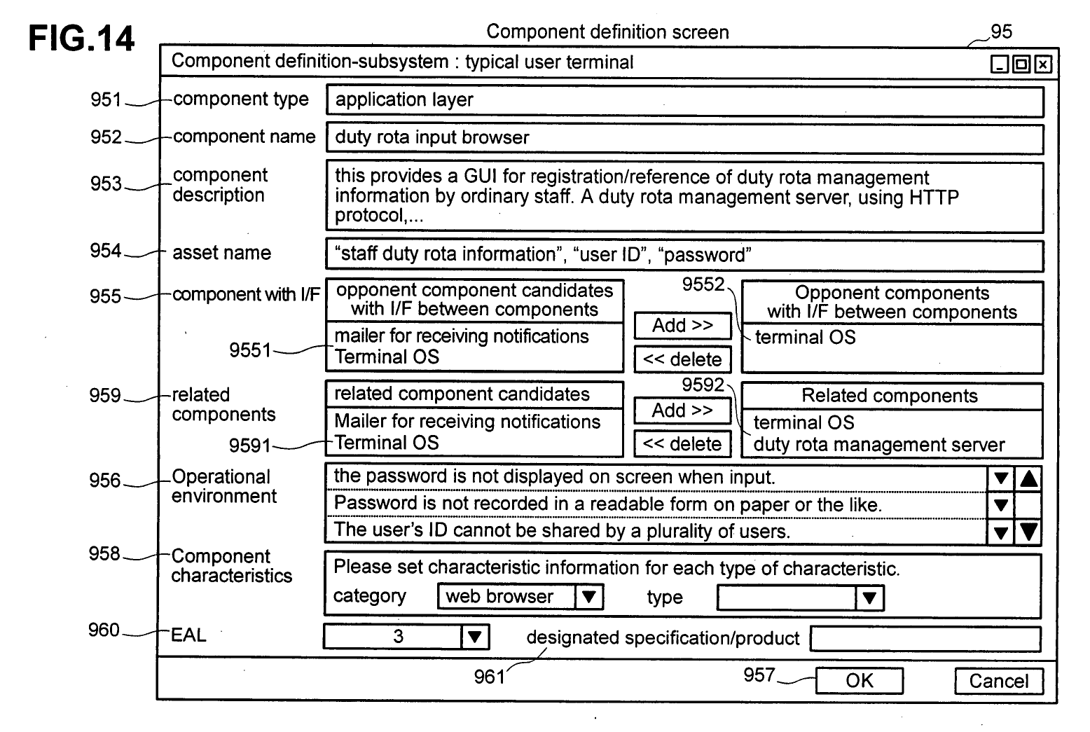

FIG. 14 shows an example of a component definition screen 95 displayed by the system configuration definition PG 5421 on the display device 56. In this example, FIG. 11 shows the display in the case where the component “duty rota input browser” 9249 is designated and the definition information of the component “duty rota input browser” 9249 is stored in the definition information storage region 554 of the system to be designed.

As shown in the Figure, the component definition screen 95 has, as input columns for the component-specific information, input columns 951 to 954, 958, 960 and 961 for component type, shown for each type of component, component name, component description, which is a detailed description of the component, assets to be protected in the component, component-specific information (category and type), target EAL (evaluation assurance level) and title of the security specification to be used as a basis or name of the existing component to be employed. The component-specific information (category and type) is employed as a search key for searching for examples of security specifications from the security specification example DB 543.

Also, the component definition screen 95 has as input columns for inter-component correspondence information a setting column 955 for setting remote components having an interface with the target component and a setting column 959 for setting other components that are functionally related to the target component. The setting column 955 has a remote candidate display column 9551 that displays in tabular form as remote component candidates components belonging to the same subsystem or components belonging to another subsystem (this subsystem can be identified by inter-subsystem correspondence information of the subsystem, in the same way as described above) that is in a connected relationship through a network and a remote display column 9552 for displaying remote components selected from this remote candidate display column 9551. The setting column 959 also, in the same way, has a related candidate display column 9591 that displays in tabular form as related component candidates components belonging to the same subsystem or components belonging to another subsystem that is in a connected relationship through a network and a related display column 9592 for displaying related components selected from this related candidate display column 9591.

Also, the component definition screen 95 has an input column 956 for inputting the operation environment such as the objectives and assumptions to be applied to the target component. It should be noted that, in the definition information storage region 554 of the system to be designed, nothing is displayed in the input columns 951 to 954, 956, 958, 960 and 961, remote display column 9552 and related display column 9592 in a condition in which no definition information of the designated component is stored i.e. a condition in which definition information of the component in question has not yet been accepted.

When a user inputs appropriate information to the input columns 951 to 954, 956, 958, 960 and 961 through the terminal input/output device 52 and selects a remote component or a related component, causing a remote component or related component to be displayed in the remote display column 9552 or related display column 9592, and selects the OK button 957, the system configuration definition PG 5421 registers or updates in the definition information storage region 554 of the system to be designed, as the definition information of the component in question, the component-specific information, inter-component correspondence information and operation environment information displayed in the input columns 951 to 954, 956, 958, 960 and 961, remote display column 9552 and related display column 9592 (S7116 of FIG. 9).

When a component type is input to the component type input column 951, the system configuration definition PG 5421 looks up a subsystem operation environment pattern 5451 from the operation environment example DB 545 using as search key the subsystem type included in the definition information of the subsystem to which the target component belongs and in addition may extract operational environment information of the target component from the operation environment pattern 5451 that is detected, by using as search key the component type that was input to the input column 951. The extracted operation environment information may then be displayed as the initial value of the input columns 956 for the operational environment. For example, if the subsystem type to which the target component belongs is “IT device”, the system configuration definition PG 5421 searches for the operational environment pattern 5451 of the subsystem type “IT device”. Also, if the component type “application layer” is input in the input column 951, the operation environment information of the component type “application layer” is extracted from the detected operation environment pattern 5451 and this is initially displayed in the input column 956. In this way, the burden of creating operational environment information for the target component can be reduced.

By proceeding as described above, S711 (the flow shown in FIG. 9) of FIG. 8 is executed and the definition information of the system to be designed is registered/updated in the definition information storage region 554 of the system to be designed.

Next, the operating procedure and screen layout in S712 to S716 (creation/registration of a security specification draft of the respective components) of FIG. 8 will be described.

As shown in FIG. 10(D), when the user selects the item “component specification draft creation” 9231 from the item “Tools” 923 of the menu bar in the TOE definition screen 92 by operating the cursor (not shown), the security specification selection PG 5422 executes S712 to S716 of FIG. 8, with the respective components identified by the definition information of the system to be designed designated as noted components.

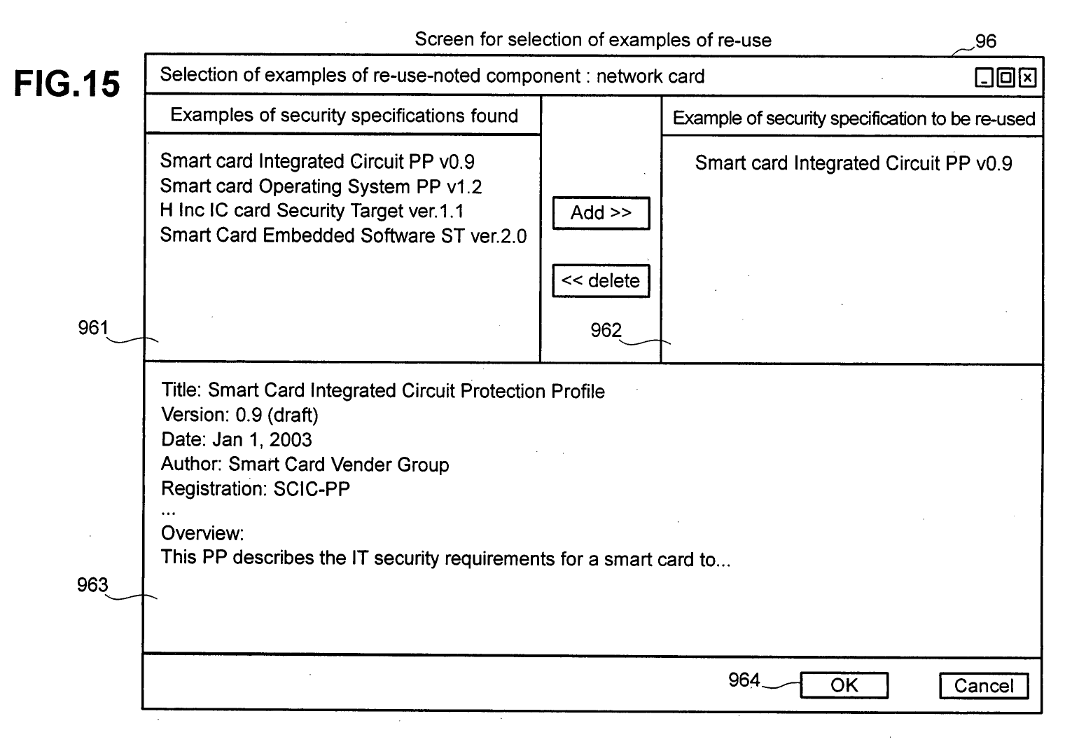

FIG. 15 shows an example of a reusable example screen 96 displayed on the display device 56 by the security specification selection PG 5422. Using as a search key the noted component-specific information (category, type) 958, existing security specifications found from the security specification example DB 543 are displayed in the display frame 961. The display frame 963 displays the details of the security specification of a title selected by the user from the titles displayed in the display frame 961 by operating the cursor (not shown). By referring to the details of the security specifications displayed in the display frame 963, the user can verify the compatibility etc of the various items of information (target EAL, operation environment, sub-systems to which the noted component belongs) set out in the definition information of the noted component with the security specification in question. In this way, a decision as to whether or not the security specification in question is capable of re-use with the noted component can be made in an appropriate fashion. Also, the display frame 962 displays the title of the security specification of the title selected from the display frame 961 as a security specification capable of re-use, in response to operation of the cursor (not shown) by the user. When the OK button 964 is selected in a condition in which the title is displayed in the display frame 962, the security specification selection PG 5422 designates (step S714 of FIG. 8) the security specification having this title as a reusable security specification in respect of the noted component.

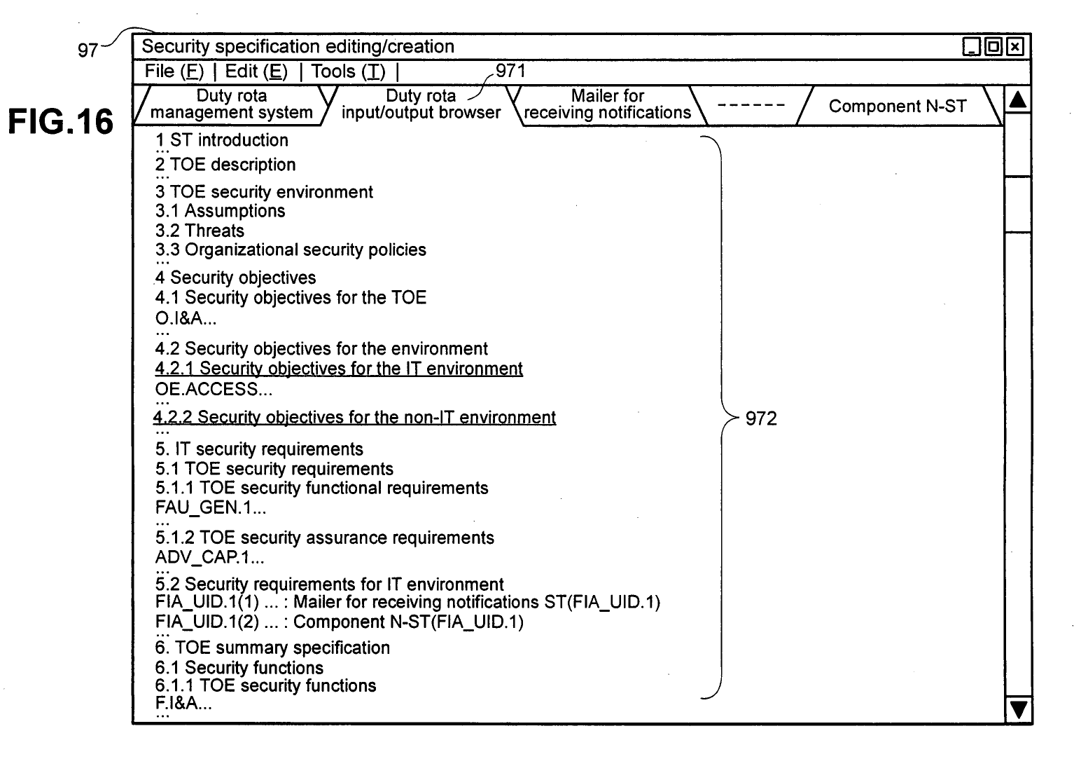

FIG. 16 shows an example of a security specification creation/editing screen 97 displayed on the display device 56 by the security specification draft creation PG 5423. If an example of a security specification capable of re-use in respect of a noted component is selected by the security specification selection PG 5422, the security specification draft creation PG 5423 displays the details of this security specification in the editing region 972 that is identified by the tag 971 of the noted component of the security specification creation/editing screen 97. Editing of the security specification by the user through the terminal input/output device 52 is then accepted. Then, if registration instructions are accepted from the user, the security specification that is displayed in the editing region 972 is designated as the security specification draft for the noted component and is stored in the security specification draft storage region 555 together with the information of the security specification draft (title or other details). It should be noted that, if no example of a specification that is reusable in respect of the noted component is selected, nothing is displayed in the editing region 972 identified by the tag 971 of the noted component, in the initial condition. The user must therefore initially enter a security specification draft for the noted component in the editing region 972 identified by the noted component tag 971 (S714, 715 of FIG. 8).

In this way, S712 to S716 of FIG. 8 are executed and the security specification draft of the noted components of the system to be designed are registered/updated in the security specification draft storage region 555.

Next, using FIG. 10, the operational procedure and screen layout in S717, S718 of FIG. 8 (creation/registration of a composite security specification draft of the system to be designed) will be described.

As shown in FIG. 10(D), when the item “composite specification draft creation” 9232 is selected from the item “Tools” 923 of the menu bar in the TOE definition screen 92 by the user operating the cursor (not shown), the security specification draft creation PG 5423 reflects the details of the security specification draft of the components stored in the security specification draft storage region 555 in the form of security specification that has been prepared beforehand and thereby automatically creates a composite security specification draft in respect of the system to be designed (S717 of FIG. 8).

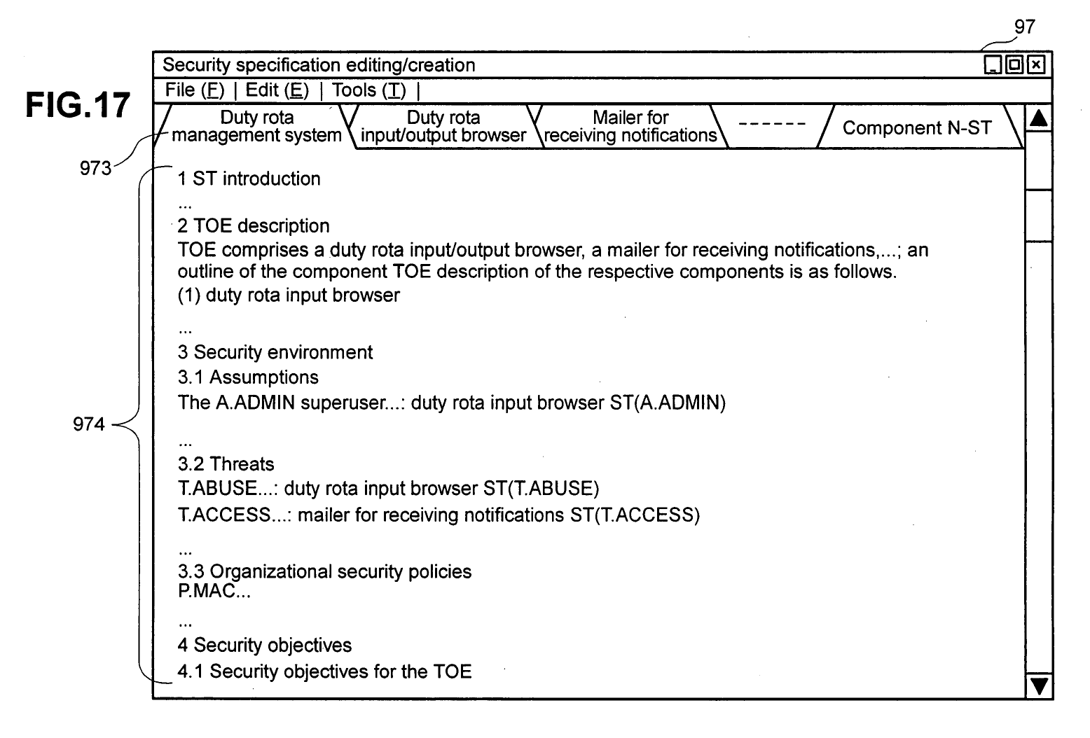

FIG. 17 shows an example of a security specification creation/editing screen 97 displayed on the display device 56 by the security specification draft creation PG 5423. The security specification creation/editing screen 97 shown in FIG. 17 displays the composite security specification draft that was automatically created by the security specification draft creation PG 5423, in the editing region 974 identified by the tag 973 of the system to be designed in the security specification creation/editing screen 97 shown in FIG. 16. The security specification draft creation PG 5423 accepts editing of the composite security specification displayed in the editing region 974 from the user through the terminal input/output device 52. If registration instructions are then accepted from the user, the composite security specification displayed in the editing region 974 is then stored in the security specification draft storage region 555. The system security specification draft of the system to be designed is thereby registered (S718 of FIG. 8) in the security specification draft storage region 555.

As described above, FIG. 11 shows the TOE definition screen 92 that is displayed when the item “TOE definition support” 9111 is selected in a condition in which the definition information of the system to be designed has been stored in the definition information storage region 554 of the system to be designed and the system security specification draft has been stored in the security specification draft storage region 555. The nodes of the components are displayed in such a way that it is possible to identify whether or not an existing security specification has been used for the creation of the security specification draft. This can be ascertained by checking whether or not the information (title or other details) of the security specification draft that was re-used is attached to the security specification draft of the component stored in the security specification draft storage region 555. Component nodes 9249, 9247, 9251, 9252 and 9254 to 9256 using existing security specifications are displayed with a black-shaded circular mark; component nodes 9246, 9248, 9250 and 9253 in which no existing security specification is used are displayed with a white circular mark. In this way, the user can ascertain whether or not evaluations of such components have been made.

Also, in FIG. 11, if all of the components belonging to a subsystem use an existing security specification, the node of the subsystem in question is shown in a way such that this fact can be identified. The node 9245 of the subsystem “duty rota management server”, in respect of which existing security specifications are used for all the components belonging to the subsystem itself is displayed with a black-shaded triangular mark; the node 9244 of the subsystem “typical user terminal”, which is not such a subsystem, is displayed with a white triangular mark. In this way, the user can ascertain whether or not an evaluation of the subsystem has been made. The same applies to domains.

Also, in the TOE definition screen 92 shown in FIG. 11, in the display frame 925, if a component of a node selected by operation of the cursor (not shown) by the user re-uses an existing security specification, the information of this existing security specification (title or other details) is displayed from the system deployment tree displayed in the display frame 924.

With this embodiment, the definition information of the components constituting the system to be designed is accepted from the user. Next, a check is made concerning the respective components as to whether or not a security specification that is capable of re-use exists in the security specification example DB 543 and if such a security specification exists this is identified. After this, the details of the respective security specifications that have thus been identified are reflected to a form of security specification that was previously prepared, thereby automatically generating a composite security specification draft in respect of the system to be designed; this draft is then presented to the user. Revision of the composite security specification draft from the user is then accepted. By proceeding in this way, creation of a security specification draft of a system to be designed by a user who does not have specialist knowledge/techniques or know-how can be supported.

In more detail, this embodiment has the following benefits.

(1) By automatically generating a composite security specification draft in respect of the system to be designed and adding or revising only information concerning differences, the number of steps involved in creating a security specification can be reduced.

(2) By re-using existing (certified) security specifications in respect of each component, work requiring specialized techniques and knowledge such as risk analysis can be reduced. In this way, the analytical work, which occupies most of the time in security designed, can be reduced, making it possible to reduce the amount of design work, which tends to become enormous, in network systems constituted of a plurality of elements.

(3) By re-using existing (certified) security specifications in respect of each component, it becomes possible to create a security specification draft of a guaranteed fixed quality, making it possible to reduce the evaluation costs of an information network system, which are liable to become enormous, due to its being constructed from a plurality of elements.

(4) A system to be designed can be analyzed and defined by constituent elements based for example on system requirements and system security design can thereby be achieved without inconsistency with the system configuration.

(5) In for example conducting system security design consultations with clients, a high-quality consultation service can be rapidly provided by using the security specification example DB 544 stored on portable storage media.

It should be noted that the present invention is not restricted to the above embodiments and could be modified in various ways within the scope of its gist.

For example, in the above embodiments, the security specification draft creation PG 5423 can be arranged to automatically create a component security specification draft not merely of a system to be designed but also domain units or subsystem units. The automatic creation of composite security specification drafts for domains or subsystems may be made to reflect the security specification draft details of each component belonging to the target domain or subsystem, in a previously prepared form of security specification. The automatically created composite security specification draft may then be presented to the user for acceptance of revisions.

Also, just as in the case of a component security specification, the component security specification of the domains or subsystems created from the component security specification draft of the domains or subsystems may be registered in the security specification example DB 543. The composite security specifications of subsystems are converted into database form so that they can be searched using as key the subsystem type (information input in the input column 941 of FIG. 13) or the component-specific information constituting the subsystem (information that is input in the input column 958 of FIG. 14). Also, the composite security specifications of domains are converted into database form so that they can be searched using as key the subsystem type of the subsystems constituting the domain or the specific information of the components constituting the respective subsystems.

In this way, it is possible to search for reusable examples of composite security specifications for domains or subsystems in respect of each of the domains or subsystems, from the system definition information of the system to be designed stored in the definition information storage region 554 of the system to be designed. Thus, by reflecting the composite security specification detected in respect of the domain or subsystem to the form of component security specification as a composite security specification draft of the domain in question or subsystem in question in the same way as in the case of the security specification draft of the components belonging to the domains or subsystems other than the domains in question or subsystems in question, the amount of work in creating a security specification for a large system having partial layouts which are identical or similar can be reduced.

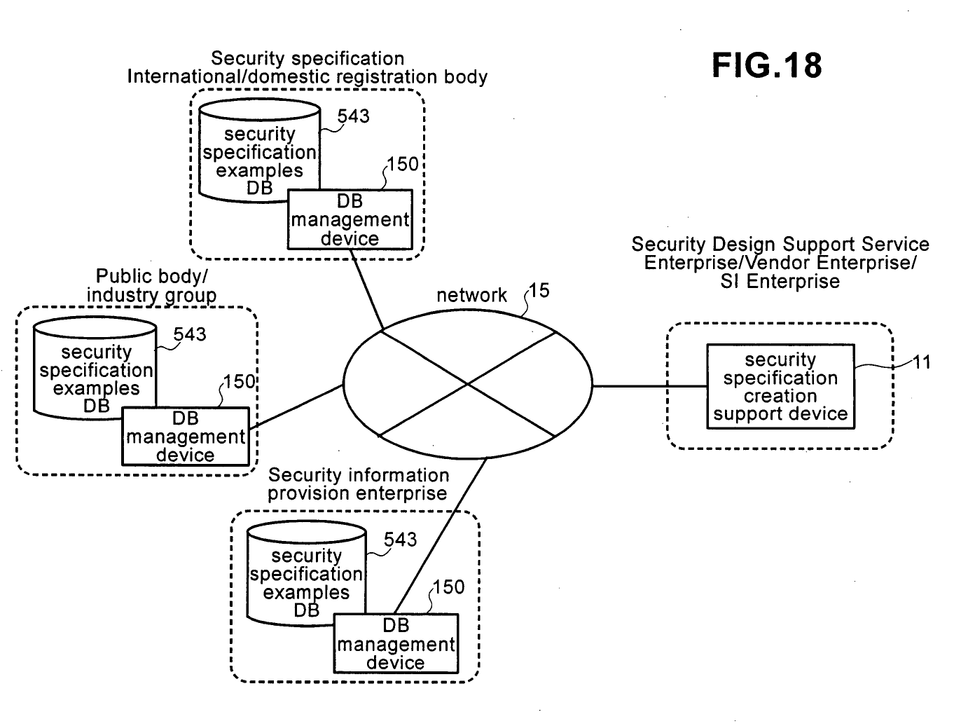

Also, in the above embodiments, it is not necessary for the DB 543 to 545 to be locally connected to the security specification creation support device 11 and they could be arranged to be available on the network. FIG. 18 is a view showing a modified example of a security specification creation support device 11.

The security specification creation device 11 shown in FIG. 18 is installed at for example a security design support service enterprise or vendor enterprise or SI (system integrator) enterprise and is connected with a DB management device 150 of for example an international/national registration body for security specifications or a public body that creates and manages procurement requirement specifications for public administrative departments, an industry group that regulates industry standards or an enterprise that obtains profit by providing security information through an network 15 such as a LAN or WAN. Also, a security specification example DB 543 is connected with the DB management device 150.

In this security specification creation support device 11, the security specification selection PG 5422 acquires examples of reusable security specifications by accessing the security specification example DB 543 through the network IF device 58 and DB management device 150. In this way, it is possible to efficiently select the optimum specification for the subject of design from a large number of different types of existing security specifications that are dispersed on a network 15 or to directly acquire the latest security specification specified by a public

1. A security specification creation support device that supports creation of a security specification in respect of an information network system, comprising:
a security specification example database in which existing security specifications are registered as examples;
a definition information acceptance unit that accepts definition information of respective components constituting the information network system from a user;
a security specification selection unit that looks up reusable examples from the security specification example database based on definition information of the component accepted by the definition information acceptance unit in respect of the respective components; and
a security specification draft creation unit that creates a composite security specification draft in respect of an information network system by entering the details of respective examples found by the specification selection unit in a prescribed form of security specification and accepts revisions of the draft from the user.

2. The security specification creation support device according to claim 1, wherein:
the security specification selection unit, when at least one reusable example is detected from the security specification example database in respect of the respective components, allows a user to select an example for re-use from the detected examples and uses this selected example as a security specification draft for the component and accepts from the user revisions of this draft, and when no reusable example is detected from the security specification example database, creates security
specification drafts of the respective components by accepting from the user a security specification draft of the components; and
the security specification draft creation unit creates the composite security specification draft by entering the details of the security specification drafts of the respective components in the prescribed form of security specification.

3. The security specification creation support device according to claim 2, wherein the security specification draft creation unit creates the composite security specification draft, such that portions where details of the security specification drafts of the respective components can be identified.

4. The security specification creation support device according to claim 1, wherein the definition information acceptance unit accepts from the user definition information of respective domains obtained by dividing the information network system into operational environment units, definition information of respective subsystems obtained by dividing these domains into device units in respect of the respective domains, and definition information of the respective components obtained by dividing these subsystems into minimum units for security analysis in respect of the respective subsystems.

5. The security specification creation support device according to claim 4, wherein the security specification draft creation unit creates a composite security specification draft of the domain or the subsystem by entering the details of the security specification draft of the respective components belonging to the domain or the subsystem in a prescribed form of security specification.

6. The security specification creation support device according to claim 5, wherein:
in the security specification example database, previously created composite security specifications of domains and subsystems are registered as examples, and
the security specification selection unit looks up examples of composite security specifications of domains or subsystems that can be re-used from the security specification example database, based on the definition information of the domain or subsystem accepted by the definition information acceptance unit, in respect of the respective domains or the respective subsystems.

7. The security specification creation support device according to claim 4, further comprising a system configuration example database in which typical patterns of component configurations in respect of a plurality of respective subsystems are registered as examples,
wherein the definition information acceptance unit identifies a typical pattern of component configuration of the subsystem from the system configuration examples based on the subsystem definition information accepted from the user, and accepts definition information from the user in respect of respective components indicated by the component configuration of identified typical pattern.

8. The security specification creation support device according to claim 4, further comprising a tree display unit that displays respective domains, subsystems and components whose definition information has been accepted by the definition information acceptance unit, in a tree structure in which layer relationship in the information network system can be identified.

9. The security specification creation support device according to claim 8, wherein the tree display unit displays respective components constituting the same subsystem in a layer structure in which a layer relationship in the subsystem can be identified.

10. The security specification creation support device according to claim 8, wherein the tree display unit displays respective components in such a way that whether or not an example has been detected by the security specification selection unit can be identified.

11. The security specification creation support device according to claim 1, wherein the security specification example database is arranged separated from the security specification selection unit, with communication there between through a network.

12. A program product capable of being read by a computer for supporting creation of a security specification in respect of an information network system, which comprises:
a definition information acceptance program that accepts definition information of respective components constituting the information network system from a user;
a security specification selection program that looks up reusable examples from a security specification example database in which existing security specifications are registered as examples based on definition information of the component accepted by the definition information acceptance unit in respect of the respective components; and
a security specification draft creation program that creates a composite security specification draft in respect of an information network system by entering the details of respective examples found by the security specification selection unit in a prescribed form of security specification and accepts revisions of the draft from the user.

13. A security specification creation support method that supports creation of a security specification in respect of an information network system using a computer
in which a security specification example database in which existing security specifications are registered as examples is stored in a storage device of the computer or in another computer connected with the aforesaid computer through a network, and
the computing device of the computer performs operations comprising:
accepting from the user definition information of respective components constituting the information network system;
selecting a security specification by looking up reusable examples from the security specification example database based on the accepted definition information in respect of the respective components; and
creating a composite security specification draft in respect of the information network system by entering the details of respective examples found by the security specification selection step in a prescribed form of security specification and accepting revisions of the draft in question are accepted from the user.
